(19) United States
(12) Patent Application Publication
(10) Pub. No.: US 2013/0291368 A1
(43) Pub. Date: Nov. 7, 2013

(54) Cooled Part for Expansion Circuit Board Cooling

(71) Applicant: Niall Thomas Davidson, Hamilton (GB)

(72) Inventor: Niall Thomas Davidson, Hamilton (GB)

(21) Appl. No.: 13/465,169

(22) Filed: May 7, 2012

(51) Int. Cl. B21D 53/02; H01R 13/02

(52) U.S. Cl. 29/592.1; 439/485; 439/487

(57) ABSTRACT

Disclosed is a method and apparatus for contacting the thermal connectors of expansion circuit boards characterized by having a thermal connector. The apparatus configured to be contacted by the thermal connector of an expansion circuit board when the expansion circuit board is installed and cooled by a combination of cooling means and heat transfer means including heatpipes, fans and heatsinks.

### CROSS-REFERENCE TO RELATED APPLICATIONS

The present application is related to copending application Ser. No. 13/465,053 filed on the same day as the present application by inventor Niall T. Davidson, copending application Ser. No. 13/465,053 is herein incorporated by reference and is not admitted to be prior art with respect to the present invention by its mention in the background or cross-reference section.

### BACKGROUND

Expansion circuit boards are widely used in electronic systems, examples of electronic systems which make extensive use of expansion circuit boards are server computer systems and personal computer systems which use expansion circuit boards in the form of expansion cards which install into expansion slots to extend the computers capabilities and provide additional features. Designers of the expansion slots used in such computers provide electrical and mechanical specifications so that interested third-parties can design and build expansion cards that will work in these slots.

There are many examples of expansion cards on the market today, these include graphics cards, network cards, IO cards and many more. Some expansion cards are no more than a circuit board with a few ICs, whilst others provide access to sophisticated processors that are sold with cooling hardware attached to prevent overheating.

Expansion cards which are sold with their own cooling solutions include graphics cards, general purpose GPU compute devices, hardware RAID and high end network cards, these cards use cooling solutions that range from a single heatsink to a combination of heatsinks, fans and other cooling apparatus. Due to the positioning of expansion slots and the proximity of other expansion cards these cooling solutions must perform within a restricted space which may not be favorable for the task and heat dissipated by some of these cooling systems increases the temperature inside the enclosure which in turn increases the temperature of other components and can lead to additional cooling fans being added to the enclosure to reduce the temperature of the enclosure and provide adequate airflow.

The cooling solutions used by some expansion cards can increase their size and weight significantly and some cards take up so much space that their installation precludes the use of neighboring expansion slots. Additionally, the use of fans significantly increases the noise output of the computer, introduces a point of mechanical failure and, because of the space limitations, are limited in size and therefore are louder and potentially less efficient than they could be otherwise.

Expansion circuit boards characterized by having a thermal connector, similar to those described by copending application Ser. No. 13/465,053, contact a cooled part to cool their components, there is therefore a need for such cooled parts.

### SUMMARY

The present invention is directed to a method and apparatus that satisfy this need, apparatus embodying features of the present invention comprise one or more locations to which a thermal connector can be contacted.

Disclosed are cooled parts which comprise one or more locations to which a thermal connector can be contacted, the cooled parts configured for use with expansion circuit boards which are characterized by having a thermal connector. Examples of such expansion circuit boards are described by copending application Ser. No. 13/465,053.

One apparatus having features of the present invention comprises a manifold thermal connector with a plurality of locations where a thermal connector can be contacted, the manifold thermal connector thermally connected via heatpipes to a finned heatsink with optional fans providing increased air flow over the heatsink.

Another apparatus having features of the present invention comprises a manifold thermal connector with a plurality of locations where a thermal connector can be contacted, the manifold thermal connector configured to attach to an enclosure and transmit heat via heatpipes to a heatsink.

Other apparatus described having features of the present invention comprise a manifold thermal connector adapted such that a liquid coolant can be used to cool the manifold thermal connector.

Among the advantages of the apparatus described is the flexibility to position a cooling means for the cooled part in an advantageous location and the possibility to utilize a cooling means which may be otherwise unsuitable for use.

### DRAWINGS

These and other features, aspects, and advantages of the present invention will become better understood with regard to the following description, appended claims, and accompanying drawings where:

FIGS. 1, 2 and 3 show exploded views of example thermal connectors and their respective counterpart thermal connectors;

FIG. 4 shows a top view of a manifold thermal connector with six contactable locations, two of which are indicated;

FIG. 5 shows a view of the manifold thermal connector of FIG. 4 with heat transmitting means and cooling means attached;

FIG. 6 shows a view of the apparatus of FIG. 5 mounted on a computer motherboard;

FIG. 7 shows a view of the motherboard and mounted apparatus of FIG. 6 with an expansion card installed, a thermal connector on the expansion card contacting a location on the manifold thermal connector;

FIG. 8 shows a view of the motherboard of FIG. 6 installed in an enclosure, with several expansion cards installed and fans positioned to direct air across the finned heatsink;

FIG. 9 shows a view of an enclosure with an attached manifold thermal connector, heat transmitting means and cooling means;

FIG. 10 shows a view of the enclosure of FIG. 9 with a motherboard and expansion card installed;

FIG. 11 shows a view of a liquid cooled manifold thermal connector with five contactable locations;

FIG. 12 shows the liquid cooled manifold thermal connector of FIG. 11 installed in a motherboard with an expansion card installed, a thermal connector on the expansion card contacting the liquid cooled manifold thermal connector;

FIG. 13 shows a liquid cooled manifold thermal connector with two contactable locations;

FIG. 14 shows the liquid cooled manifold thermal connector with two expansion cards, each contacting a contactable location on the manifold thermal connector;

FIG. 15 shows an expansion slot with an integrated thermal connector with one contactable location installed on a motherboard, and;

FIG. 16 shows the expansion slot of FIG. 15 installed in an enclosure with an expansion card installed into the expansion slot and its thermal connector contacting the contactable location of the expansion slot.

### DESCRIPTION

It is intended that the following description and claims should be interpreted in accordance with Webster's Third New International Dictionary, Unabridged unless otherwise indicated.

In the following specification and claims a “heatpipe” is intended to encompass heatpipes, vapor chambers and other heat transfer devices which operate in a similar manner.

In the following specification and claims a “heat transmitting means” is intended to encompass heatpipes, vapor chambers, thermal interface materials and thermally conductive materials, composites, manufactures and apparatus such as: thermally conductive metals examples of which include copper, aluminium, beryllium, silver, gold, nickel and alloys thereof; thermally conductive non-metallic materials examples of which include diamond, carbon fiber, carbon nanotubes, graphene, graphite and combinations thereof; composite materials and manufactures examples of which include graphite fiber/copper matrix composites and the encapsulated graphite system sold under the trademark k-Core by k Technology of Langhorne Pa., and; apparatus such as liquid circulation, heat pumps and heat exchangers. A “heat transmitting means” is further intended to encompass any means presently existing or that is discovered in the future which transmits heat from one place to another.

In the following specification and claims a “cooling means” is intended to encompass heatsinks, fins, cold plates, liquid cooling, air forced or otherwise and any means presently existing or that is discovered in the future which removes or dissipates heat.

In the following specification and claims a “thermal connector” is defined to be an apparatus, article of manufacture or portion of an apparatus or article of manufacture, the purpose of which is to transfer, transmit or communicate heat to a counterpart thermal connector when contacted with or otherwise interacting with the counterpart thermal connector. Examples of thermal connectors and their counterparts are shown in FIGS. 1, 2 and 3, however it is not intended that the definition of a thermal connector be limited to the shape and form of the examples shown, nor that they are limited to operating via physical contact, nor is it necessary that a thermal connector is distinct, it may for instance be part of an expansion circuit board which is brought into contact with a counterpart to transfer, transmit or communicate heat. A person having ordinary skill in the art will be able to devise numerous and diverse thermal connectors which can be used by apparatus embodying features of the present invention.

In the following specification and claims I have attempted to maintain the convention of referring to a thermal connector found on an expansion circuit board as the “thermal connector”, whilst referring to a thermal connector to which the thermal connector on an expansion circuit board contacts as the “counterpart thermal connector”, however both are still thermal connectors and the use of “counterpart thermal connector” or “thermal connector” does not imply a specific purpose or meaning and should not be taken as such.

In the following specification and claims a “contactable location” is defined to be an area of a thermal connector to which another thermal connector can be contacted, this definition simplifies the discussion involving thermal connectors which have a plurality of areas which are each configured to be contactable by a thermal connector.

FIG. 1 shows an example of a thermal connector 100 and its counterpart thermal connector 102 manufactured from a thermally conductive material. When the thermal connector 100 and its counterpart 102 are brought together a thermal interface 104 is created and a thermal circuit completed which allows heat to flow across the thermal interface 104. Optionally, to improve the quality of the thermal connection, a fastener such as screws 106 and springs 108 can be used to provide pressure and hold the two parts together. Thermal connector 100 offers a detachable connection, has a thermal interface 104 which is easy to clean and apply thermal interface material to, is relatively simple to manufacture and has a high tolerance for misalignment between the thermal connector 100 and its counterpart.

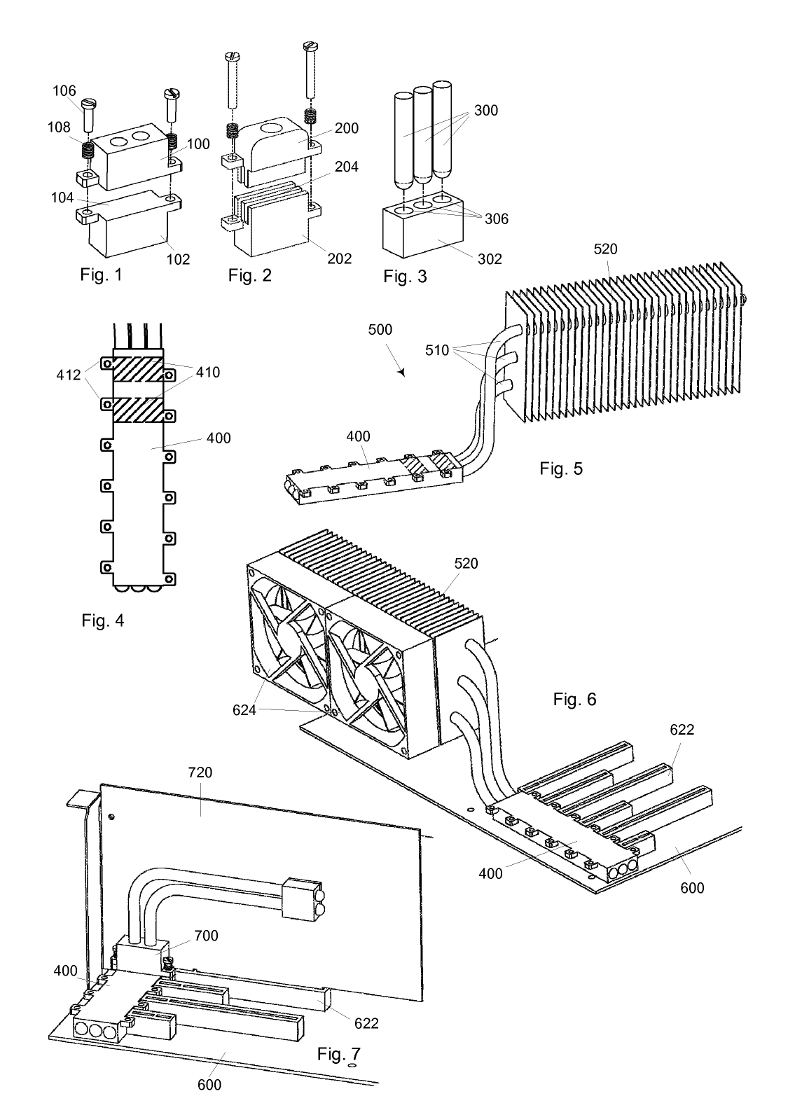

FIG. 2 shows another example of a thermal connector manufactured from a thermally conductive material, thermal connector 200 and its counterpart thermal connector 202 employ the use of finned profiles which fit together and create a thermal interface 204 across which heat can flow when brought together. Thermal connector 200 offers a detachable connection and has a thermal interface 204 with a large surface area.

FIG. 3 shows another example of a thermal connector, thermal connectors 300 are inserted into the apertures 306 to make a thermal connection. Each thermal connector 300 is the end of a heat pipe and has a corresponding aperture 306 in the counterpart thermal connector 302 into which it fits. The thermal connector of FIG. 3 has the advantage that it offers a detachable connection, and offers a direct thermal interface to a heat transfer means, thus reducing the number of thermal interfaces in the system, it also offers the capability to use a number of thermal connectors 300 less than there is apertures 306.

Expansion circuit boards of the type having a thermal connector, similar to that described by copending application Ser. No. 13/465,053, are cooled by contacting their thermal connectors to a cooled part.

A method of cooling such expansion circuit boards is described, the method comprising positioning a counterpart thermal connector so that it can be contacted by the thermal connector of the expansion circuit board and cooling the counterpart thermal connector.

The step of positioning a counterpart thermal connector so that it can be contacted by the thermal connector of the expansion circuit board is dependent on the configuration of the thermal connector and expansion circuit board. In one embodiment the installation of the expansion circuit board causes the thermal connector of the expansion circuit board to be positioned such that a counterpart thermal connector can be positioned and oriented to be contacted by it, in another embodiment the thermal connector of the expansion circuit board is configured such that a counterpart thermal connector may be positioned to contact the thermal connector before or after installation of the expansion circuit board.

The step of cooling the counterpart thermal connector can be achieved in a variety of ways, including but not limited to the use of a combination of cooling means and optional heat transmitting means, for example: a heat pipe transmitting heat from the counterpart thermal connector to a heatsink or cooled surface; dissipating heat by using fins thermally connected to the counterpart thermal connector; passing liquid coolant through channels or chambers within the counterpart thermal connector, or; the use of a combination of vapor chambers, fans and heatsinks. A person having ordinary skill in the art will be able to devise many and varied means for cooling the counterpart thermal connector.

Apparatus having features of the present invention are described, whilst the apparatus described are given in the context of a computer system it is expected that usefulness of apparatus having features of the present invention is not restricted to such. Whilst the apparatus described have a number of contactable locations and are configured to be contacted by a specific type of thermal connector it is to be understood that these are exemplary only and apparatus having features of the present invention are not limited to the number of contactable locations described or to contactable locations configured for a described thermal connector.

FIGS. 4 to 8 illustrate an apparatus having features of the present invention. FIG. 4 shows a top view of a manifold thermal connector 400 with six contactable locations. Two such contactable locations 410 are indicated by a hatched section. Each contactable location is configured to be contacted by a thermal connector similar to that illustrated in FIG. 1, with optional ears 412 available for fastening a thermal connector to the manifold thermal connector.

The manifold thermal connector 400 is manufactured from a thermally conductive material, for example copper or aluminum, however it is not necessary for surfaces which will not contact an expansion card thermal connector to be thermally conductive or thermally connected to a cooling means. The configuration of a contactable locations depends on that of the thermal connector intended to be contacted to the contactable location, in the case of thermal connectors similar to that illustrated in FIG. 1 this is a flat surface and the contactable locations of the example shown in FIG. 4 are configured to be contacted by such a thermal connector.

The manifold thermal connector 400 is configured such that it can be fitted on a motherboard and will allow the thermal connector on an expansion card to align with and contact a contactable location on the manifold thermal connector 400 when the expansion card is installed in the motherboard, see FIG. 7 for an example of an installed expansion card 720 with thermal connector 700 contacting the manifold thermal connector 400. It may also be beneficial to thermally insulate the surface of the manifold thermal connector 400 which contacts the motherboard.

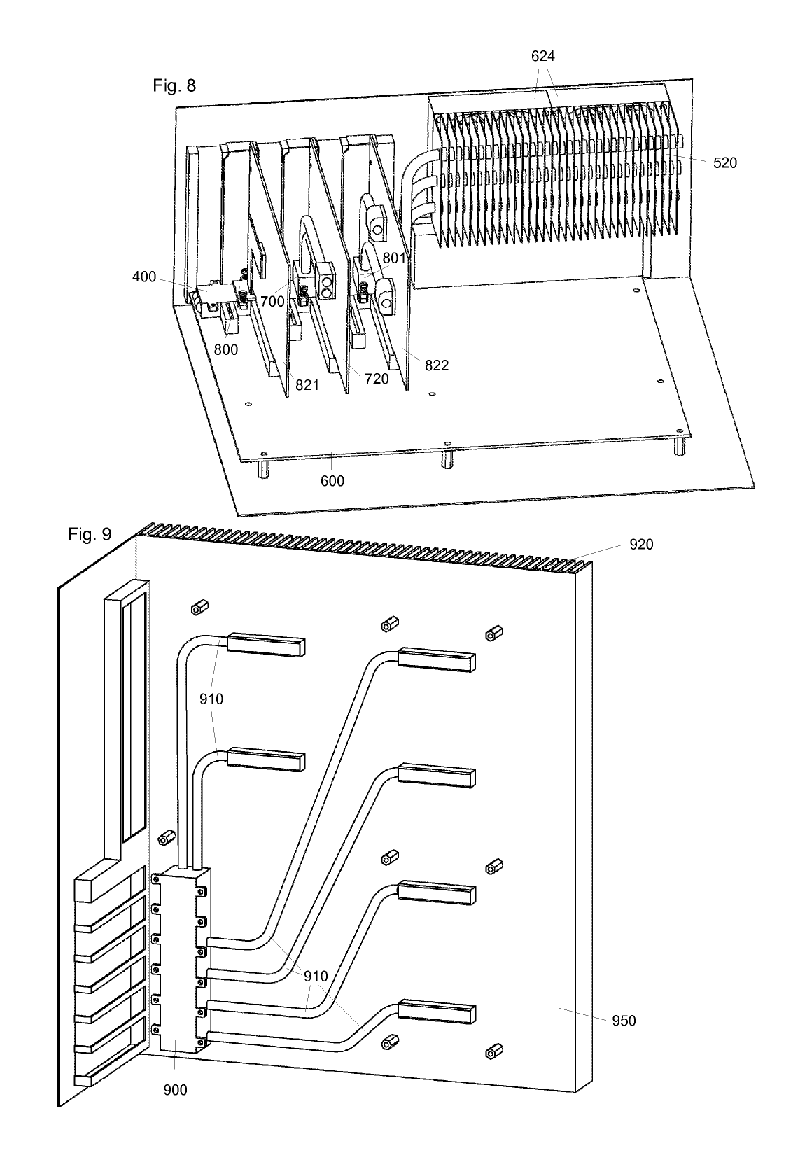

FIG. 5 shows an apparatus 500 comprising the manifold thermal connector 400 attached to a heat transmitting means comprised of heatpipes 510, the heatpipes 510 transmitting heat to a cooling means comprising heatsink 520 which comprises a plurality of fins. The evaporator end of the heatpipes 510 are thermally connected to one or more contactable locations on the manifold thermal connector 400, each contactable location being connected to at least one of the heatpipes 510, and the condensing end of the heatpipes 510 are thermally connected to heatsink 520.

FIGS. 6 and 7 show the apparatus of FIG. 5 attached to a motherboard 600, the manifold thermal connector 400 positioned in such a way that the thermal connector 700 of the expansion card 720 installed in one of the expansion slots 622 contacts and aligns with one of the contactable locations on the manifold thermal connector 400. FIG. 6 also shows optional fans 624 positioned to direct air flow through the heatsink 520.

FIG. 8 illustrates a cut away view of an enclosure containing the motherboard 600, cooled part 500 and a variety of expansion cards 720, 821 and 822 installed in the motherboard 600, each expansion card having a thermal connector 700, 800 and 801 contacting the manifold thermal connector 400 in a different contactable location. The heatsink 520 and optional fans 624 configured in such a way that the fans can be attached to the interior of the enclosure and operated to push or pull air over the heatsink 520.

An advantage of the apparatus 500 and arrangement illustrated in FIGS. 4 through 8 is that heat generated by components on the expansion cards 720,821 and 822 is transmitted to an area of the enclosure where larger fans and a larger heatsink than could be otherwise be used can be utilized to cool the manifold thermal connector 400 and thus cool the components on the expansion cards 720,821 and 822. By combining a manifold thermal connector similar to that described with heat transmitting means such as heatpipes and a cooling means, manufacturers have the flexibility to design and build a variety of apparatus embodying principles of the present invention which can be used to cool expansion cards of this type.

FIG. 9 shows a cut away view of another apparatus embodying principles of the present invention, the apparatus comprising an enclosure 950 for a computer system which has a manifold thermal connector 900 similar to that shown in FIG. 4. The manifold thermal connector 900, which is manufactured from a thermally conductive material, for example copper or aluminum, transmits heat to a cooling means comprising heatsink 920 via heat transmitting means comprising heatpipes 910 and directly between the heatsink 920 and the manifold thermal connector 900. The heatsink 920 comprising a plurality of fins which populate a surface of the enclosure 950 and presents a large surface area over which heat can dissipate.

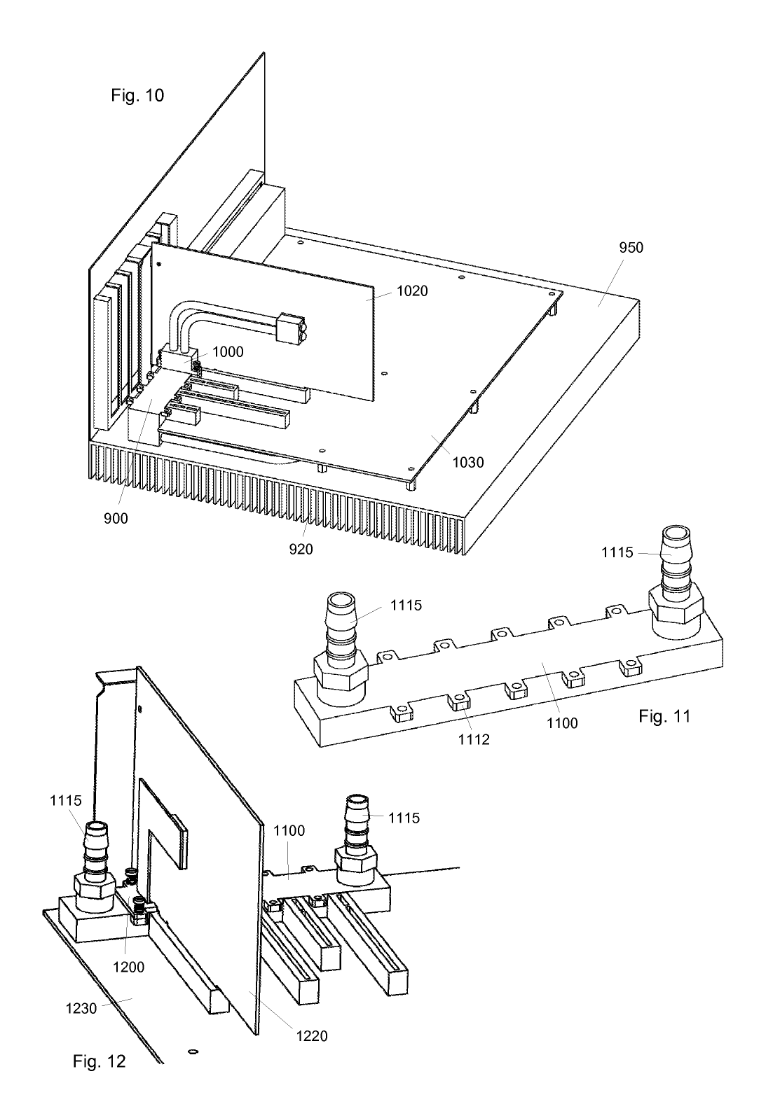

FIG. 10 illustrates a motherboard 1030 mounted in the enclosure 950, the motherboard 1030 having a notch and being positioned to allow the thermal connector 1000 of expansion card 1020 to contact and align with one of the contactable locations on the manifold thermal connector 900 when the expansion card 1020 is installed in one of the expansion slots of the motherboard 1030.

The apparatus shown in FIG. 9 has a manifold thermal connector 900 which differs from that shown in FIG. 4, the manifold thermal connector 900 is intended not to be fitted onto a motherboard but rather to be attached to the enclosure 950 with a motherboard adapted to the shape of the manifold thermal connector 900. An advantage of this is that heat transmitting means can be used which have a potentially greater capacity and as is shown in FIG. 10, heat transmitting means such as heatpipes can be run underneath the motherboard which yields greater flexibility for locating a cooling means.

Whilst FIGS. 9 and 10 show cooling means comprising heatsink 920 on one surface of the enclosure, apparatus embodying features of the present invention can be developed which use a variety of cooling means. A potential advantage of such a heatsink 920 is that the large surface area may provide sufficient cooling to cool the manifold thermal connector 900 and any installed expansion cards without requiring fans, thus removing any associated noise and reducing the associated risk of mechanical failure.

FIG. 11 shows another apparatus embodying principles of the present invention, the apparatus comprising a liquid cooled manifold thermal connector 1100 with five contactable locations. Each contactable location is configured to be contacted by a thermal connector similar to that illustrated in FIG. 1, with ears 1112 for fastening the thermal connector to the manifold thermal connector. The manifold thermal connector 1100 manufactured from a thermally conductive material for example copper or aluminum and having an internal channel connecting the pair of barbed pipe connectors 1115 through which a liquid coolant can be passed, the liquid coolant cooling the manifold thermal connector 1100. The liquid cooled manifold thermal connector 1100 shown is designed to be fitted on a motherboard, however it could also be designed to attach to an enclosure in a fashion similar to the manifold thermal connector 900 shown in FIG. 9.

FIG. 12 illustrates the liquid cooled manifold thermal connector 1100 attached to a motherboard 1230 with an installed expansion card 1220, the manifold thermal connector 1100 being configured in such a way that when the expansion card 1220 is installed in one of the expansion slots the thermal connector 1200 of the expansion card 1220 contacts and aligns with a contactable location on the manifold thermal connector 1100.

An advantage of the liquid cooled manifold thermal connector 1100 is that heat can be efficiently removed by a liquid coolant without the need to drain down the system every time a user wants to liquid cool a new expansion card, it also enables an efficient means of heat transfer to a cooling means somewhere else within or outside of the computer system.

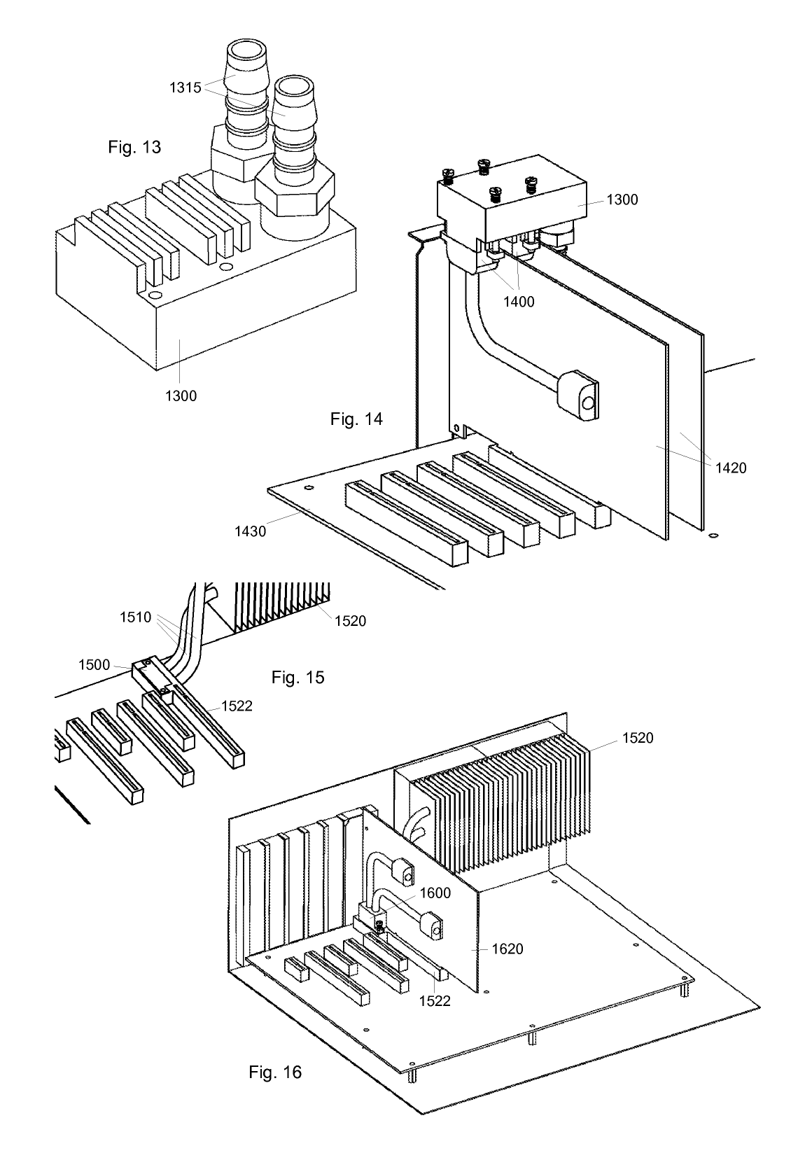

FIG. 13 shows another apparatus embodying principles of the present invention, the apparatus comprising a liquid cooled manifold thermal connector 1300 with two contactable locations. Each contactable location is configured to be contacted by a finned thermal connector similar to that illustrated in FIG. 2. The manifold thermal connector 1300 manufactured from a thermally conductive material, for example copper or aluminum, and having an internal channel connecting the pair of barbed fittings 1315 through which a liquid coolant can be passed, the liquid coolant cooling the manifold thermal connector 1300.

FIG. 14 shows the liquid cooled manifold thermal connector 1300 of FIG. 13 and a pair of expansion cards 1420, the expansion cards installed in a motherboard 1430. The manifold thermal connector 1300 is fitted either before or after installation of the cards and contacts the two thermal connectors 1400 of the expansion cards, by passing liquid coolant through the manifold thermal connector 1300 the thermal connectors 1400 can be cooled.

FIG. 15 shows another apparatus comprising features of the present invention, the apparatus comprising an expansion slot 1522 with integrated thermal connector 1500, the integrated thermal connector having a single contactable location configured to be contacted by a thermal connector similar to that illustrated in FIG. 1 when an expansion card is installed. The integrated thermal connector 1500 manufactured from a thermally conductive material for example copper or aluminum and is attached to a heat transmitting means comprising heatpipes 1510 which transmit heat to a cooling means 1520.

FIG. 16 shows the apparatus of FIG. 15 installed in an enclosure with an expansion card 1620 installed in the expansion slot 1522, the thermal connector 1600 of expansion card 1620 contacting the integrated thermal connector 1500.

Other possible configurations of an expansion slot with integrated thermal connector include but are not limited to: an expansion slot with integrated thermal connector, the integrated thermal connector configured to extend beneath a motherboard through a cutout in the motherboard where it can be thermally connected to heat transmitting means or cooling means, and; an expansion slot with integrated thermal connector, the integrated thermal connector configured to be thermally connected to a cooling means or heat transmitting means such as heatpipes which is routed from below via a cutout in the motherboard.

Although specific embodiments of the invention have been shown and described herein, it is to be understood that these embodiments are merely illustrative of the many possible specific arrangements that can be devised in application of the principles of the invention. Numerous and varied other arrangements can be devised by those of ordinary skill in the art without departing from the scope and spirit of the invention.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specified function, is not to be interpreted as a “means” or “step” clause as specified in 35 U.S.C. §112, ¶6. In particular, the use of “step of” in the claims herein is not intended to invoke the provisions of 35 U.S.C §112, ¶6.

What I claim is:

1. A method for cooling an expansion circuit board of the type characterized by having a thermal connector which is contacted with a counterpart thermal connector, the method comprising:
(a) positioning a counterpart thermal connector in such a way so that it can be contacted by the thermal connector of the expansion circuit board, and;
(b) cooling the counterpart thermal connector.

2. An apparatus for contacting a thermal connector of an expansion circuit board, the apparatus comprising a counterpart thermal connector configured to be contacted by the thermal connector.

3. The apparatus of claim 2 further comprising cooling means, the cooling means thermally connected to the counterpart thermal connector.

4. The apparatus of claim 2 wherein the counterpart thermal connector is a thermally conductive surface.

5. The apparatus of claim 4 further comprising cooling means, the cooling means thermally connected to the thermally conductive surface.

6. The apparatus of claim 2 further comprising a heatsink, the heatsink thermally connected to the counterpart thermal connector.

7. The apparatus of claim 6 further comprising a heatpipe, the heatpipe thermally connecting the counterpart thermal connector to the heatsink.

8. The apparatus of claim 2 further comprising a channel through which a liquid coolant can be passed, the channel thermally connected to the counterpart thermal connector.

9. The apparatus of claim 2 wherein the counterpart thermal connector is configured to be contacted by the thermal connector of the expansion circuit board when the expansion circuit board is installed.

10. The apparatus of claim 9 wherein the counterpart thermal connector comprises a thermally conductive surface.

11. The apparatus of claim 2 wherein the configuration of the counterpart thermal connector is specified by an industry body.

12. An apparatus comprising a counterpart thermal connector, the counterpart thermal connector configured to be contacted by a thermal connector attached to an expansion card.

13. The apparatus of claim 12 wherein apparatus is adapted to be fitted to a computer motherboard in such a way that the thermal connector attached to the expansion card contacts the counterpart thermal connector when the expansion card is installed.

14. The apparatus of claim 12 wherein the counterpart thermal connector comprises a thermally conductive surface, the thermally conductive surface being configured to be contacted by the thermal connector attached to the expansion card.

15. The apparatus of claim 14 adapted to be fitted to a computer motherboard in such a way that the thermal connector attached to the expansion card contacts the thermally conductive surface when the expansion card is installed.

16. The apparatus of claim 12 further comprising a means for cooling the counterpart thermal connector.

17. The apparatus of claim 12 further comprising a heatpipe thermally connected to the counterpart thermal connector.

18. The apparatus of claim 17 further comprising a plurality of fins thermally connected to the heatpipe.

19. The apparatus of claim 12 wherein the counterpart thermal connector is further configured to a specification created by an industry body.

20. An expansion slot with the apparatus of claim 12.

21. An enclosure with the apparatus of claim 12.

22. A motherboard with the apparatus of claim 12.
